(19) United States
(12) Patent Application Publication
(10) Pub. No.: US 2016/0306784 A1
(43) Pub. Date: Oct. 20, 2016

(54) Audio Onboarding Of Digital Content With Enhanced Audio Communications

(71) Applicant: AudioEye, Inc., Tucson, AZ (US)

(72) Inventors: Nathaniel T. Bradley, Tucson, AZ (US); James Crawford, Fall City, WA (US); Sean D. Bradley, Tucson, AZ (US); Mark Baker, Marietta, GA (US)

(21) Appl. No.: 15/132,140

(22) Filed: Apr. 18, 2016

Related U.S. Application Data
(60) Provisional application No. 62/148,497, filed on Apr. 16, 2015.

(51) Int. Cl. G06F 17/24; G10L 13/027; G06F 17/27; G06F 17/30; G06F 3/16; G10L 15/26; G06F 17/22

(52) U.S. Cl. CPC G06F 17/243; G10L 15/26; G10L 13/027; G06F 17/2211; G06F 17/30569; G06F 3/167; G06F 17/2705; G06F 17/2288; G06F 17/2247

(57) ABSTRACT

Systems and methods for populating an on-line form using voice interaction. The method includes: parsing the form into: i) a first field to be filled in by a user; and ii) a first text identifier associated with the first field; converting the first text identifier to first synthesized speech; playing the first synthesized speech aloud to thereby prompt the user to respond with a first verbal answer; converting the first verbal answer to a first text response; and inserting the first text response into the first field.

### CROSS-REFERENCE TO RELATED APPLICATION

This is a non-provisional application of U.S. Provisional Application No. 62/148,497, filed Apr. 16, 2015.

### BACKGROUND OF THE INVENTION

The use of and development of Internet-based technologies has grown nearly exponentially in recent years. Thousands of web pages and other Internet or digital content is created each day. The growth is fueled by larger networks with more reliable protocols and better communications hardware available to manufacturers, service providers, and consumers. In many cases, Internet content is created with the assumption that a user will be visually consuming the content. However, there are many users that do not consume Internet content visually. For example, many users have disabilities that make traditional consumption of Internet content difficult or impossible. In addition, many users prefer to hear content rather than (or in addition to) reading the content visually. Newly passed legislation, rules, and standards may also require that Internet content be made available audibly as well.

### BRIEF DESCRIPTION OF THE DRAWINGS

The present embodiments may be better understood, and numerous objects, features, and advantages made apparent to those skilled in the art by referencing the accompanying drawings.

FIG. 1 is a pictorial representation of an audio system in accordance with an illustrative embodiment;

FIG. 2 is a flowchart of an onboarding process in accordance with an illustrative embodiment;

FIG. 3 is a flowchart of a process for creating a reader mode visualization of all content in accordance with an illustrative embodiment;

FIG. 4 is a flowchart of a process for adding valid content to the stack in accordance with an illustrative embodiment;

FIG. 5 is a flowchart of a process for editing content in accordance with an illustrative embodiment;

FIG. 6 is a flowchart of a process for updating audio content in accordance with an illustrative embodiment;

FIG. 7 is a flowchart of a loader process in accordance with an illustrative embodiment;

FIG. 8 is a flowchart of a process initializing a player in accordance with an illustrative embodiment;

FIG. 9 is a flowchart of a process for playing an audio file in accordance with an illustrative embodiment;

FIG. 10 is a flowchart of a process for determining compliance of a webpage in accordance with an illustrative embodiment;

FIG. 11 is a flowchart of a process for automatically configuring a webpage in accordance with an illustrative embodiment;

FIG. 12 is a pictorial representation of basic commands for an audio player in accordance with an illustrative embodiment;

FIG. 13 is a pictorial representation of content display preferences in accordance with an illustrative embodiment;

FIG. 14 is a block diagram of a device in accordance with an illustrative embodiment.

### DETAILED DESCRIPTION OF THE PREFERRED EMBODIMENTS

The illustrative embodiments provide a system, method, devices, and computer program products for converting Internet content, including web pages and other files, and communicating the audio content to one or more users. In one embodiment, the systems may provide real-time auto-discovery and audio enablement (RADAE) of Internet content. The embodiments described herein may be described as an audio platform or system including hardware and/or software.

Many websites have millions of pages of content. Because of the sheer volume of the associated Internet content manual conversion of one or more websites to an audio waiting equivalent or to include audio content may be impossible. The described embodiments provide an automated approach to audibly enable a website and other content through onboarding. For example, users may want to configure specific pages' components with personalized or professional audio content utilizing an automated process. Onboarding is the process of converting Internet content to the audio equivalent. As a result, the time-to-market associated with the implementation of the audio system is significantly reduced. The illustrative embodiments provide a system for streamlining the onboarding process while providing additional flexibility to the providers of the Internet content. For example, fewer technical resources are required of the service providers and customers thereby increasing efficiency and reducing costs. The illustrative embodiments may also provide user-invoked TTS generation combined with intelligent caching to save significant amounts of time and money over time. In addition, site updates may be easily processed becoming inconsequential.

In one embodiment, the illustrative systems and methods may be utilized to assess a user website including the applicable structure and content. Next, a strategic decision is made to determine which content (if not all) may be read professionally or by key organization stakeholders. Next, the system tests for accuracy and compliance. During the process, layout helpers may be configured (as needed) to optimize the user experience. As individual users request page content, the corresponding audio may be played back to the user through the browser, plug-in, application, or so forth through the applicable player.

General updates and changes to the system and applicable software are processed automatically. Any number of reporting metrics and information may be made available to the user through a dashboard. The onboarding process may include performing a site survey, performing RADAE configuration, dynamic interaction, form maximization, quality assurance, and production.

In one embodiment, a logic engine auto detects page elements, components, and content. The page content may then be normalized into a consistent and accessible site structure. Audio generation of the Internet content may be invoked automatically or by the user when requesting specific page elements. The illustrative embodiments provide for specific optimization that is handled through the implementation and execution of layout helpers. As a result, pre-existing onboarding processes requiring extensive administrators, conversion specialists, and others are improved upon. In addition, previous solutions have required audio mirror images for TTS file generation (not required by the described embodiments) exponentially increasing costs to the user. Likewise, site updates have often required client involvement to appropriately generate the associated audio content rather than implementing the automatic or semi-autonomous embodiments herein described.

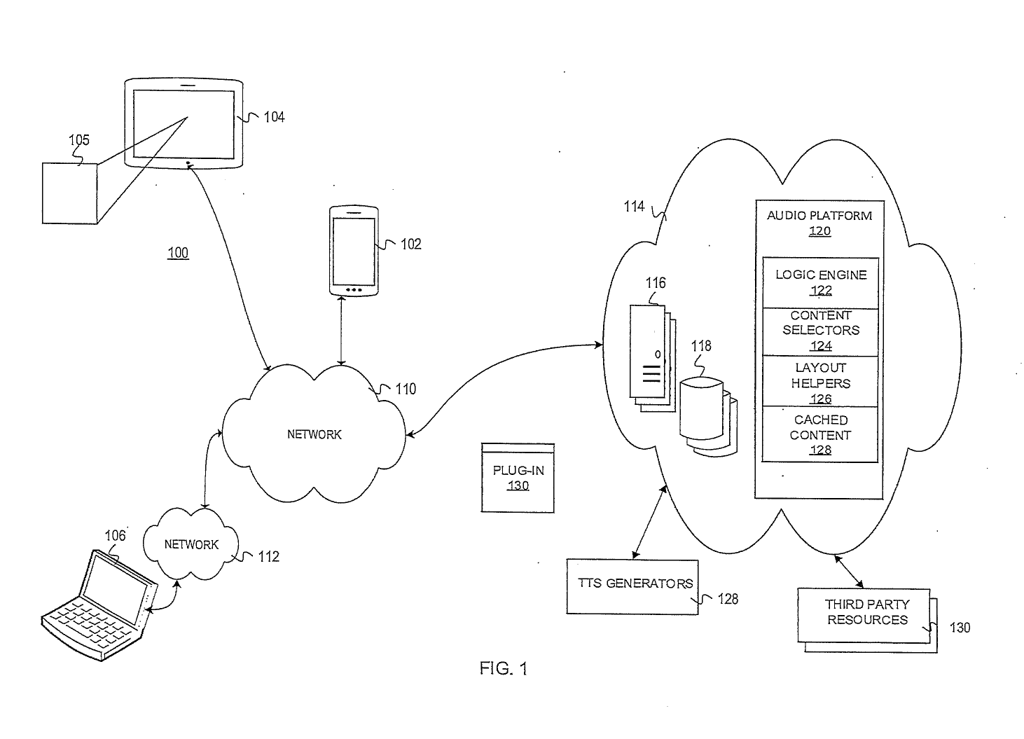

FIG. 1 is a pictorial representation of an audio system 100 in accordance with an illustrative embodiment. The audio system 100 may be composed of any number of devices and components, including, but not limited to client devices (e.g., wireless devices, cell phones, desktops, tablets, etc.), servers, storage devices, computers, network devices, connectors, and connections, intelligent network devices, and so forth. The devices and networks may represent any number of public, private, or hybrid devices, service providers, and networks utilized for wired and wireless communication. For example, the audio system 100 may represent a number of customers and a provider configured to provide Software as a Service (SaaS) to a number of users utilizing different devices and interfaces (e.g., mobile application, web browser add-in, dedicated program, etc.). Terminology between the different Figures may represent identical, similar, or distinct devices, systems, platforms, modules, and software components.

The different components of the audio system 100 may communicate using wireless communications, such as satellite connections, 4G, 5G, WiFi, WiMAX, CDMA wireless networks, and/or hardwired connections, such as fiber optics, Ti, powerline communications, cable, DSL, high speed trunks, and telephone lines. Any number of developing connection types, standards, and protocols may also be utilized herein. For example, communications architectures including cloud networks, mesh networks, powerline networks, client-server, network rings, peer-to-peer, n-tier, application server, or other distributed or network system architectures may be utilized.

In one embodiment, the audio system 100 may include a mobile device 102, tablet 104 displaying a user interface 105, a laptop 106, networks 110, 112, 114, servers 116, databases 118, audio platform 120 including engine 122, content selectors 124, layout helpers 126, and cached content 128, TTS generators 130, and third party resources 132.

The network 114 may represent a data center or cloud system of a communications service provider, content provider, or other organization that makes content more accessible for users of distinct customers. The audio platform 120 may include the servers 116 and databases 118. The servers 116 and databases 118 may store web content or audio content associated with customers or audio content available for customers. For example, the third party resources may include third party webservers that host content that is converted to audio content for delivery to one or more end-users. The servers 116 may include mail servers, server platforms, web servers, application servers, dedicated servers, cloud servers, file servers, database servers, and so forth. In one embodiment, the servers 116 may represent a server farm. The databases 118 store the structured data utilized by the audio platform 120 including audio content, associated data/metadata, content provider, applicable dates (e.g., submission, update, conversion, etc.), and other applicable information, links, pointers, or files.

In one embodiment, the network 114 hosts the resources utilized to provide audio content to any number of devices including, for example, the mobile device 102, tablet 104, and the laptop 106. Any number of other devices, clients, or so forth may communicate with the networks 110, 112, 114. The mobile device 102 may represent any number of cell phones, Blackberry devices, gaming devices, personal digital assistants, audio or video players, global positioning systems, wireless cards, multi-mode devices, vehicle communications devices, communications enabled personal accessories (e.g. clothes, watches, jewelry, etc.). The tablet 104 may represent any number of handheld wireless devices, gaming systems, or so forth. The laptop 106 may represent any number of personal computing devices, such as the shown laptop 106, desktops, glass-enabled devices, vehicle systems (e.g., car computer, GPS, entertainment system, etc.). The audio system 100 may further include any number of hardware and software components that may not be shown in the example of FIG. 1 (e.g., wireless towers, wires, routers, network interface devices, repeaters, servers, computing resources, etc.).

In one embodiment, the logic engine 122 may include the logic and algorithms utilized to perform the methods and processes herein described. The logic engine 122 may represent an application specific integrated circuit (ASIC), field programmable gate array (FPGA), or digital logic and circuits. In another embodiment, the logic engine may be a software based logic and rules engine for implementing the processes herein described. The logic engine 122 may compile data, text, files, and information from any number of sources, such as those available through the network 114.

In one embodiment, the logic engine 122 may include one or more processors. The other client devices (e.g., wireless device 102, tablet 104, client 106, vehicles, wearable computing devices and displays, electronic glass devices, etc.) may also include processors, memories, software, and other components and features of the audio platform 120 as are described. The processor is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements. The memory is a hardware element, device, or recording media configured to store data for subsequent retrieval or access at a later time. The memory may be static or dynamic memory. The memory may include a hard disk, random access memory, cache, removable media drive, mass storage, or configuration suitable as storage for data, instructions, and information. In one embodiment, the memory and processor may be integrated. The memory may use any type of volatile or non-volatile storage techniques and mediums.

The content selectors 124 and layout helpers 126 are provided as examples of modules that may be utilized by the audio platform 120 to make content available for conversion to audio content. For example, the content selectors may ensure the content is in a format that may be utilized by the logic engine 122 to perform audio conversion. The layout helpers 126 enable the audio platform to accurately identify and interpret applying custom rules to further optimize the user experience. The cached content 128 represents files or other content that has been previously converted to audio content. The cached content 128 may include an identifier associated with a website and/or the content itself for quick retrieval when requested or required. The cached content 128 may also store additional types of content, data, or information.

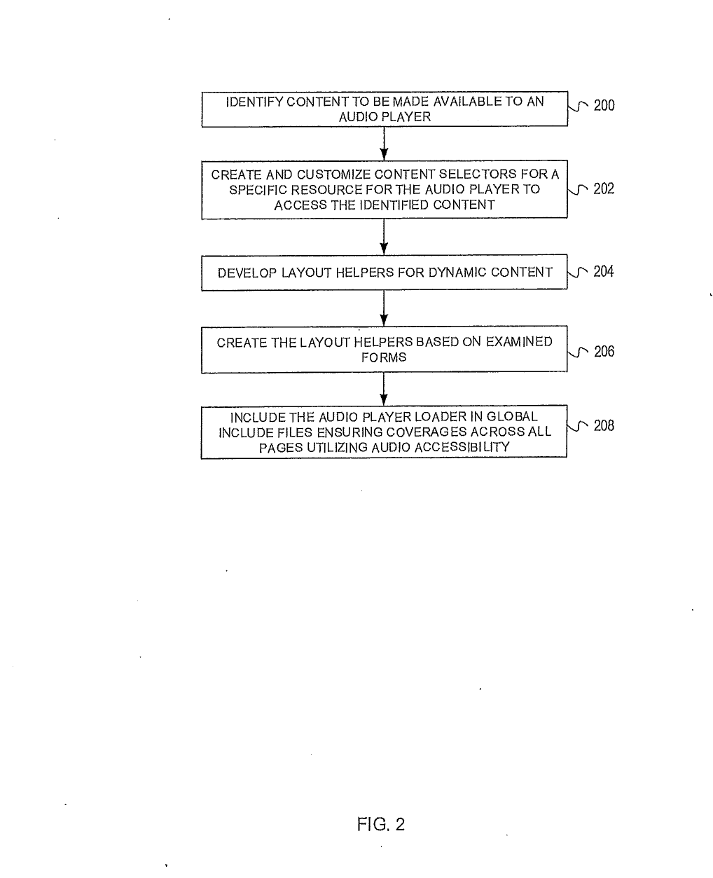

The processes of FIGS. 2-9 may be implemented by an audio system (or “system”), such as all or portions of the audio system 100 and audio platform 120 of FIG. 1. The audio system may represent hardware specific, software specific, or combined resources and components for performing various processes, operations, and/or features. The steps, processes, features and details of FIGS. 2-9 may be mixed, swapped, nested, or otherwise reconfigured to achieve audio and communications systems, methods, devices, and functionality as herein described. The system may utilize any number of modes or menus for processing and presenting information, such as a reader display mode, a site display mode, a screen reader mode, navigation, page focus, table focus, form focus, and help menu.

FIG. 2 is a flowchart of an onboarding process in accordance with an illustrative embodiment. In one embodiment, the process begins by identifying content to be made available to an audio player (step 200). The content may include web content or other network accessible content that is to be made available for an audio Internet player, such as the player herein described.

The content may be identified automatically or based on user input. The content identified during step 200 may be found during a site survey or scanning process to analyze, measure, or quantify the components and information associated with a selected website. For example, a user representing an organization ABC may request that ABC's website be made available audibly to comply with applicable laws and to reach additional potential customers.

The request may be processed automatically by the system (which may potentially include a contract, payment, terms of use, and so forth). In another embodiment, the content is identified by the audio system in response to user selections identifying user content that is to be made available in audible and other formats. For example, the content may require formatting for consumption by users with no or limited vision, hearing, disabilities, or for users that may have permanent or temporary content consumption limitations. In one embodiment, only the content that is most frequently accessed may be identified as being available to the audio player.

Next, the system creates and customizes content selectors for a specific resource for the audio player to access the identified content (step 202). In one embodiment, the specific resources are one or more websites associated with the identified content.

Next, the system develops layout helpers for dynamic content (step 204). The layout helpers are developed for AJAX and other dynamic content.

Next, the system creates the layout helpers based on examined forms (step 206). During step 206, a number of forms of the website are examined and when appropriate, the layout helpers are created ensuring compatibility with the audio player. The system may also perform quality assurance to ensure that all of the content has been examined with layout helpers created where necessary.

In one embodiment, the system may perform form population using voice interaction. For example, a form available on the website may be converted to audio such that the form may be completed in a conversation format. The fields of the form may be converted to questions that the user may answer using voice interaction. For example, the form may include fields for name, date of birth, and social security number. Once the user has navigated to the form (and selected to enter information), the system “speaks” the questions to the user, the user speaks the answers to the questions, and the system converts the user's spoken answers to text and fills in the corresponding fields.

Next, the system includes the audio player loader in global include files for the resources ensuring audio coverage across all pages utilizing audio accessibility (step 208). As a result, any number of directives may be updated that causes the audio file to be inserted into the original file.

Pre-launch testing may be performed for any website that is configured to be utilized with the audio platform. Through an administrative portal, portal domains may be configured in a “test mode.” In test mode, previewing and testing the audio platform for the publisher site may require the inclusion of the JavaScript file on any and all pages that are to be tested. Once implemented, the publisher may leverage a unique, customizable command to launch the audio player on the user site. Engaging the audio player through the custom command allows key stakeholders to preview the audio experience on their site before making the audio player publicly available to all web visitors. In addition, the audio platform provides downloadable browser extensions that eliminated any need to embed JavaScript to enable testing. During the testing process, layout helpers may be configured for non-standard source content. The layout helpers enable the audio platform to accurately identify and interpret applying custom rules to further optimize the user experience.

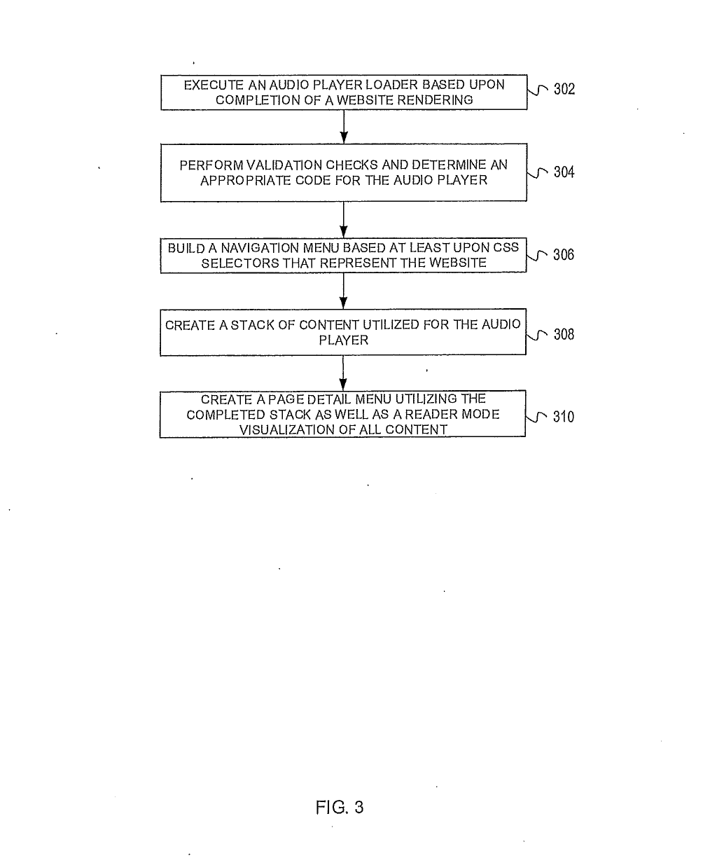

FIG. 3 is a flowchart of a process for creating a reader mode visualization of all content in accordance with an illustrative embodiment. In one embodiment, the audio platform may implement a real-time auto detection and audio enablement that allows for dynamic content to be made accessible. In one example, websites that are so enabled may follow a workflow, process, or method as is described. The process of FIG. 3 may begin by executing an audio player loader based upon completion of a website rendering (step 302). For example, once the document object model (DOM) is finished rendering (e.g., when page content has finished loading), the audio player loader is executed.

Next, the system performs validation checks and determines an appropriate code for the audio player (step 304).

Next, the system builds a navigation menu based at least upon cascading style sheet (CSS) selectors that represent the website (step 306). In one embodiment, the CSS selectors may determine applicable lists of elements, links, and other components from a website that represent the applicable site navigation to generate the navigation menu from each of those components.

Next, the system creates a stack of content utilized for the audio player (step 308). In one embodiment, the stack is a blurb stack that includes a playlist of content that is used when building reader mode, screen reader mode, and audio versions of the site content. The stack is a data structure that stores information (e.g., active subroutines and addresses being utilized) for playing the converted or generated audio content accessed by the audio player.

Next, the system creates a page detail menu utilizing the completed stack as well as a reader mode visualization of all content (step 310). In one embodiment, once the blurb stack is available with automatically and manually created content, a reader mode visualization of all content is created by the audio player utilizing the page detail menu.

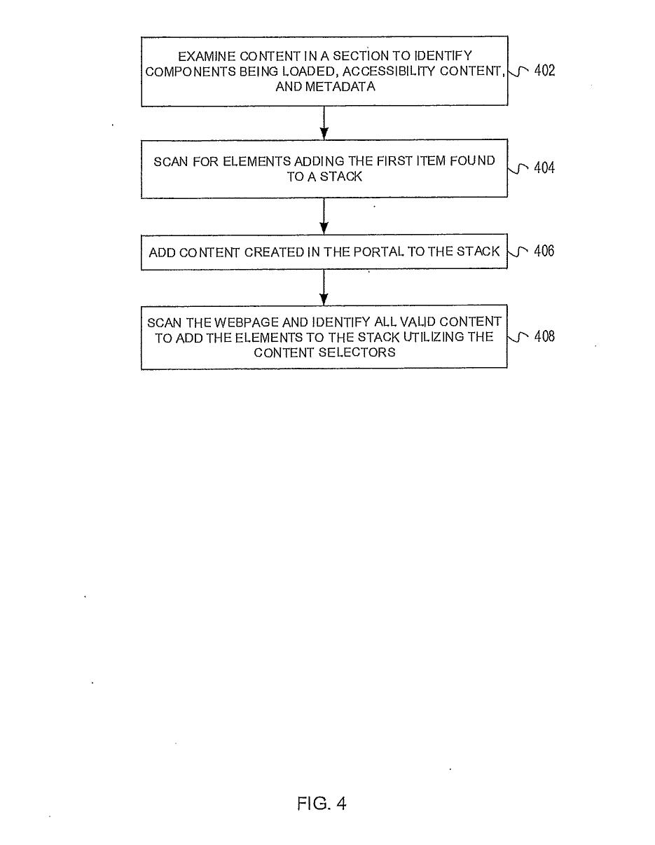

FIG. 4 is a flowchart of a process for adding valid content to a stack in accordance with an illustrative embodiment. In one embodiment, the process of FIG. 4 may be part of a process or step, such as step 308 of FIG. 3. The process of FIG. 4 may begin by examining content in a section to identify components being loaded, accessibility content and metadata (step 402). For example, the system may examine an element containing meta data (e.g., <head>, <title>, <style>, <meta>, <link>, <script>, <base>, etc.). Meta data typically defines document title, styles, links, scripts, and other meta information about the applicable digital content or webpage.

Next, the system scans for elements adding the first item found to a stack (step 404). For example, the first heading (e.g., <H1>) may be added to the stack.

Next, the system adds content created in the portal to the stack (step 406). Step 406 may allow content that does not exist on the site to be added for users of the audio player or audio system. For example, the content may be manually created for addition to the audio version of the website or digital content.

Next, the system scans the webpage and identifies all valid content to add the elements to the stack utilizing the content selectors (step 408). In one embodiment, the system may utilize the content selectors created during the onboarding process (e.g., FIG. 2) to scan the whole DOM of the webpage or content to add the valid content to the blurb stack.

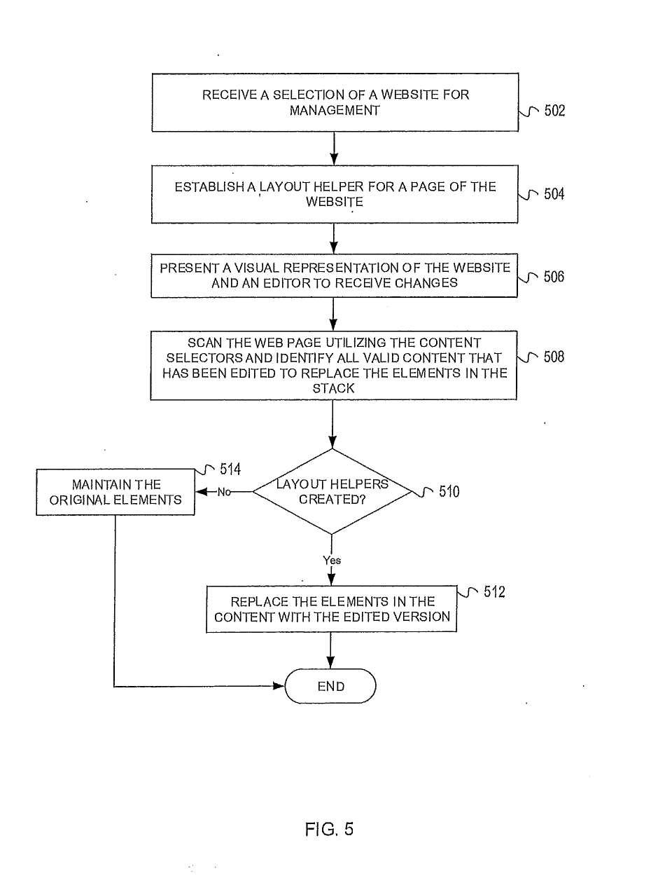

FIG. 5 is a flowchart of a process for editing content in accordance with an illustrative embodiment. The process of FIG. 5 may begin by receiving a selection of a website for management (step 502). In one embodiment, a portal available through the system may be used to select or navigate a particular website. For example, the user may log in to the management site and navigate to the specified website to perform management operations.

Next, the system establishes a layout helper for a page of the website (step 504). The layout helpers may be established automatically or based on user feedback. For example, in response to detecting errors, the system may establish errors for one or more sections or portions of a website. In another embodiment, the user may select to add manually created elements to an audio website's visualization. The system may allow a user website to configure specific page elements with personalized or professional audio while still leveraging the benefits of the automated process.

Next, the system presents a visual representation of the website and an editor to receive changes (step 506). In one embodiment, a tool, such as a scraper tool, may present a visual representation of the website page content. Selection of a specific element may allow the user to make changes using an editing tool, such as a blurb editor, to be edited and then saved.

Next, the system scans the webpage and identifies all content that has been edited to replace the elements in the stack (step 508). In one embodiment, the system may utilize the audio player to scan the content of the newly created audio page to determine if any layout helpers have been created. If layout helpers have been created, the content associated with the layout helpers may replace the corresponding element on the blurb stack.

Next, the system determines whether the layout helpers were created (step 510). If the layout helpers were created, the system replaces the elements in the content with the edited version (step 512) with the process terminating thereafter.

If the system determines that layout helpers were not created during step 510, the system maintains the original elements (step 514) with the process terminating thereafter.

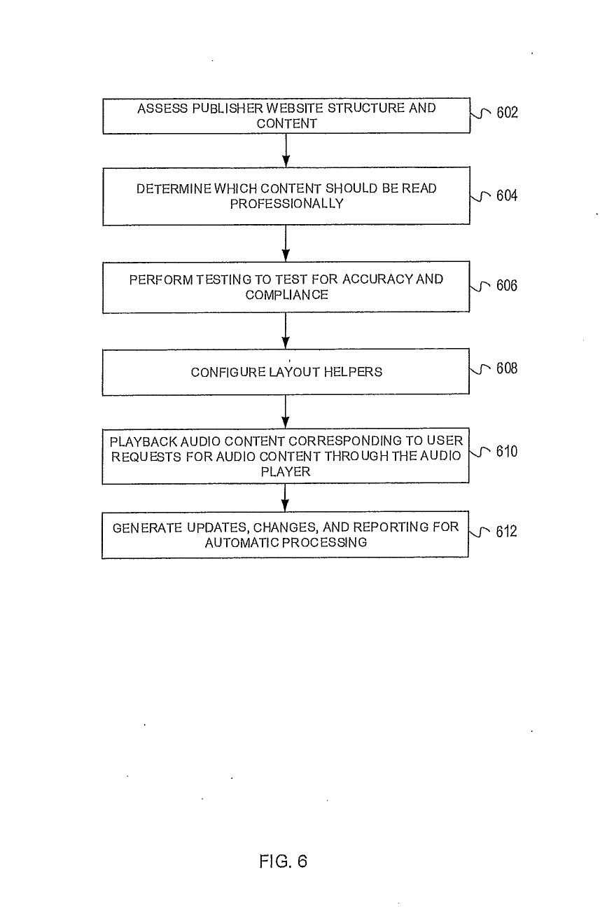

FIG. 6 is a flowchart of a process for updating audio content in accordance with an illustrative embodiment. In one embodiment, the process of FIG. 6 may be described as a real-time auto-discovery and audio enablement (RADAE) mode or process. FIG. 6 may be utilized to provide an automated approach to audio enablement for websites, apps, or other digital content. Maximum utilization of automated resources are implemented to reduce costs, conversion accuracy, and conversion times. The process of FIG. 6 may begin by assessing a publisher website structure and content (step 602). As previously described, the website may also represent a mobile application or program. The website structure and content may be analyzed utilizing any number of devices, programs, or software.

Next, the system determines which content should be read professionally (step 604). In one embodiment, the determination of what content should be read professionally (and not read professionally) may be determined utilizing flags, keys, or indicators that are incorporated into the publisher website. In another embodiment, an interface may be utilized to receive a user selection of the content including sections, portions, or so forth that are to be read professionally. For example, specific content may be valuable or important and require that owners, stake holders, professional voice actors, experts, or others record audio content for association with the content.

Next, the system performs testing for accuracy and compliance (step 606).

Next, the system configures layout helpers (step 608). The layout helpers are configured to optimize the user experience when listening to and navigating the audio content associated with the publisher website.

Next, the system plays back audio content corresponding to user requests for audio content through the audio player (step 610). The system player may be accessed through a web browser, plug-in, stand-alone program, script, operating system integrated feature, or other software component utilized by any number of devices.

Next, the system generates updates, changes, and reporting for automatic processing (step 612). The system may scan or analyze the webpage periodically or at predetermined time periods (e.g. 2:00 a.m., 12:00 p.m.) to process changes and perform necessary changes. The report generation times may be preset by a user for performing the updates, changes, and reports. In addition, the information gathered and reported may be customized by one or more users. The reports may include metrics that may be made available through a software as a service (SaaS) administrator dashboard or other management interface.

As previously noted, in some cases it may be difficult to ensure a web page stays at a set level of compliance for providing access to users with disabilities. The system provides an instant or real-time way of determining compliance with any number of standards. In one embodiment, if a user is unable to access content utilizing compliant technologies, feedback may be provided. For example a hardware key or soft key may be selected, a gesture provided, voice command received, or other user interaction received to indicate the website or portion thereof (e.g., page, section, element) is non-compliant (or alternatively compliant).

In response to either a manual or automatic indication that a portion of the website is noncompliant, a product feature may be implemented to send an email, text, phone call, pop-up, or other alert to one or more administrators, operators, technicians, or specialists. For example, a call center may handle any communications regarding noncompliance to help the user resolve the issue or request help from an available party. In one embodiment, the platform may include any number of plug-ins, add-ons, JavaScript files, or other constructs for ensuring content is compliant to follow-up with a user.

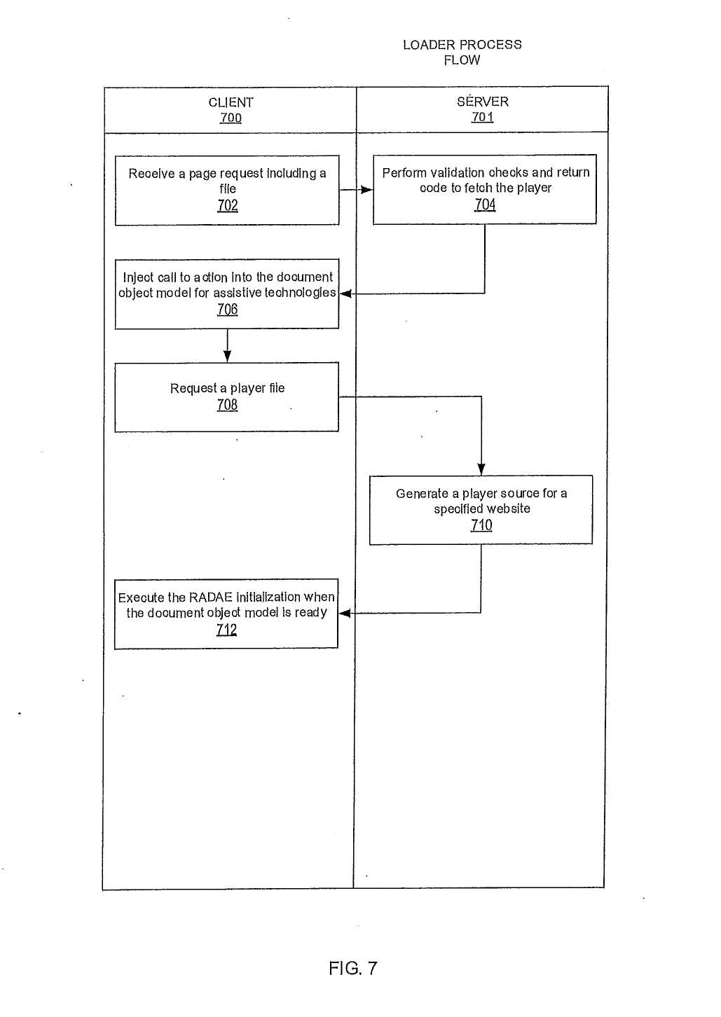

FIG. 7 is a flowchart of a loader process in accordance with an illustrative embodiment. The process of FIG. 7 may be implemented between a client 700 and a server 701. The process of FIG. 7 may begin with the client 700 receiving a page request including a file (step 702). In one embodiment, the page request includes a file extension, such as an audio platform JavaScript source code file (e.g., ae.js). In other embodiments, any number of requests may be made utilizing different languages. The file may be utilized to run a client-side code on the webpage.

Next, the server 701 performs a validation check and returns code to fetch a player (step 704). The code returned may be utilized to execute the audio player on the client 700. The code for fetching the player may have been previously fetched during step 704. For example, to implement the audio player, the licensed publisher or user may integrate the audio JavaScript library, such as “<script src=”//ws.audioeye.com/ae.js”><script>.” The script may be changed from time to time as needed. For example, account managers for the audio platform may inform individual users before embedding scripts into web pages or templates. In one embodiment, the script is placed in the global footer just below the closing </body> tag. Once applied globally, the subsequent call-to-action may be displayed in the bottom right hand corner of each page containing the script include.

Next, the client 700 injects a call to action (CTA) into the document object model (DOM) for assistive technologies (step 706). When an end-user comes to a webpage that is audio enabled, the CTA riggers a mnemonic tone and corresponding visual flash that serves to notify the user of the presence of the CTA, both audibly and visually. In some examples, engaging the audio player may be as simple as pressing the spacebar, typing an alphanumeric key or soft key, or clicking on the CTA. The assistive technologies may include screen readers, tactile features, Braille or Braille complements, screen magnifiers, or other accessibility software and devices (e.g., augmented and alternative communication components, assistive technology for cognition, etc.). In addition for users of assistive technologies, such as screen readers, a custom message may be detected by the screen reader that provides the user with instructions for how to best engage with the audio enabled website. The message read back to from their screen reader software may be “This site is audio (or AudioEye) enabled. To enter the assistive technology-optimized version of this page, please press CTRL-SHIFT-A.”

Next, the client 700 requests a player file (step 708). In one embodiment, the player file may represent a JavaScript source code file (e.g., aeplayer.js).

Next, the server 701 generates a player source for a specified website (step 710). Next, the client 700 executes the real-time auto-discovery and audio enablement initialization when the document object model is ready (step 712).

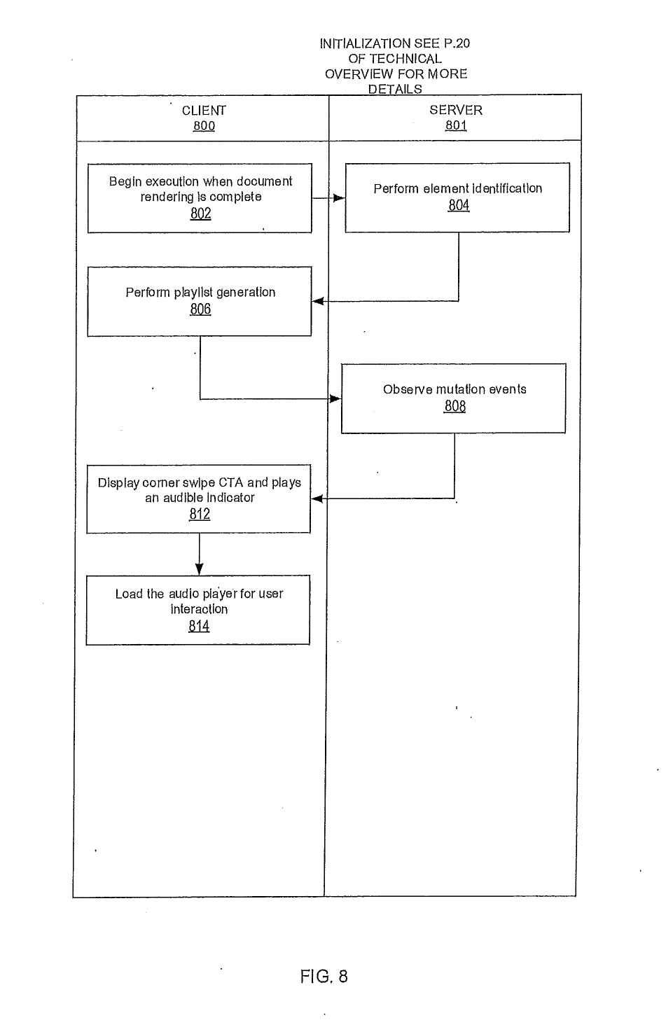

FIG. 8 is a flowchart of a process initializing a player in accordance with an illustrative embodiment. The process of FIG. 8 may be implemented by a client 80o and a server 801. The process may begin execution when document rendering is complete (step 802). In one embodiment, the audio player may be implemented to perform execution.

Next, the server 801 performs element identification (step 804). Element identification may include a number of items including a page heading. The page heading may include a configurable CSS selector. For example, a first selector match may be used as the page heading.

Element identification may also include menu identification. The menu identification may include configurable CSS selectors for numerous types of menus. For example, rules may be utilized to build clean menu structures, to nest links logically.

Next, the client 800 performs playlist generation (step 806). In one embodiment, the client may create a first playlist entry using the first page heading selector match. During playlist generation, the platform may analyze main content of the web page. For example, the platform may recurse through all child elements within the document object model that are visible to sighted users to create playlist entries for each element. During step 806, the platform may also filter out elements matched by the configurable exclude selectors, utilized heuristics to filter out elements that do not contain pronounceable text, apply pronunciation rules, and apply rules for phone numbers and email addresses for proper pronunciation.

Next, the server 801 observes mutation events (step 808). For example, the server 801 may include a mutation event observer that utilizes the audio configuration information and Accessible Rich Internet Applications (ARIA) tags to determine whether each piece of dynamic content should be played back immediately or queued.

Next, the client Boo displays a corner swipe call to action (CTA) and plays an audible indicator (step 812). The audio player may be activated in any number of ways, such as a corner swipe call to action, icon, voice command, dedicated soft button, or so forth. The user may also be presented with one or more audio indicators that inform the user that the audio player is available, selected, or being utilized.

Next, the client Boo loads the audio player for user interaction (step 814). Once the audio player is loaded, the audio player is ready for user interaction.

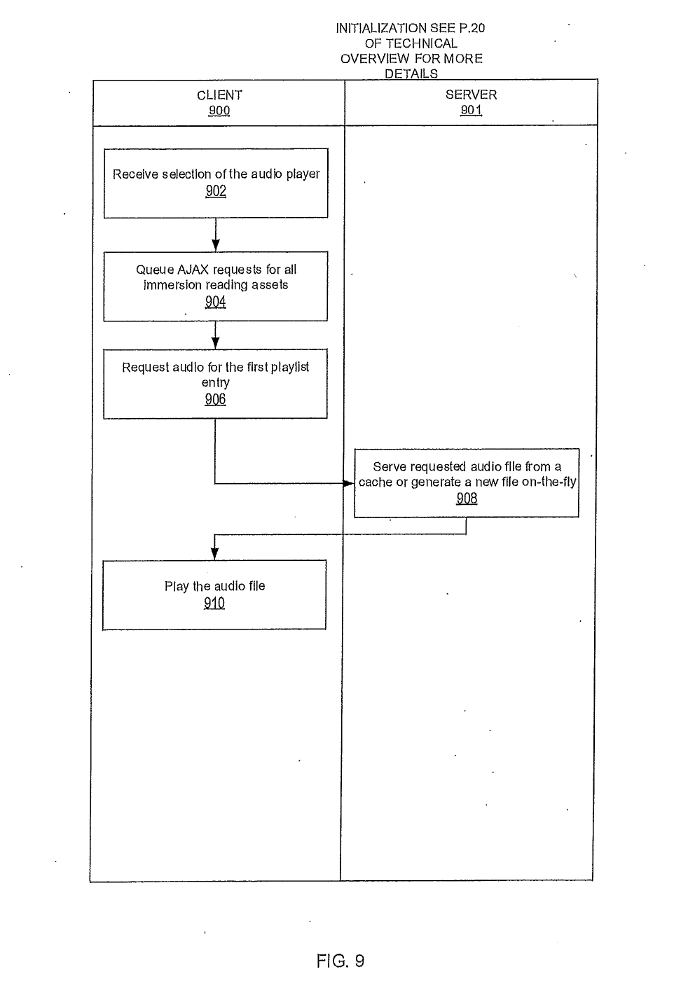

FIG. 9 is a flowchart of a process for playing an audio file in accordance with an illustrative embodiment. In one embodiment, the process of FIG. 9 may be implemented by a client 900 and a server 901 to allow the user to active the audio player. The process of FIG. 9 may begin with the client 900 receiving a selection of an audio player (step 902).

Next, the client 900 queues AJAX requests for all immersion reading assets (step 904). AJAX is short for asynchronous JavaScript and XML. The immersion reading assets may represent any number of programs or features implemented by the client 900.

Next, the client 900 request audio for a first playlist entry (step 906). The playlist entry may be associated with a selected webpage.

Next, the server 901 serves the requested audio file from a cache or generates a new file on the fly (step 908). In one embodiment, the first playlist is cached for any number of future requests. In response to audio being requested, the server 901 serves the requested audio file that is part of the playlist entry.

The process ends with the client 900 playing the audio file (step 91o). The audio file may be played audible, tactilely, presented textually, or otherwise communicated to the user. During step 910 any number of files associated with the first playlist may be played in a predetermined order, sequentially, or as designated.

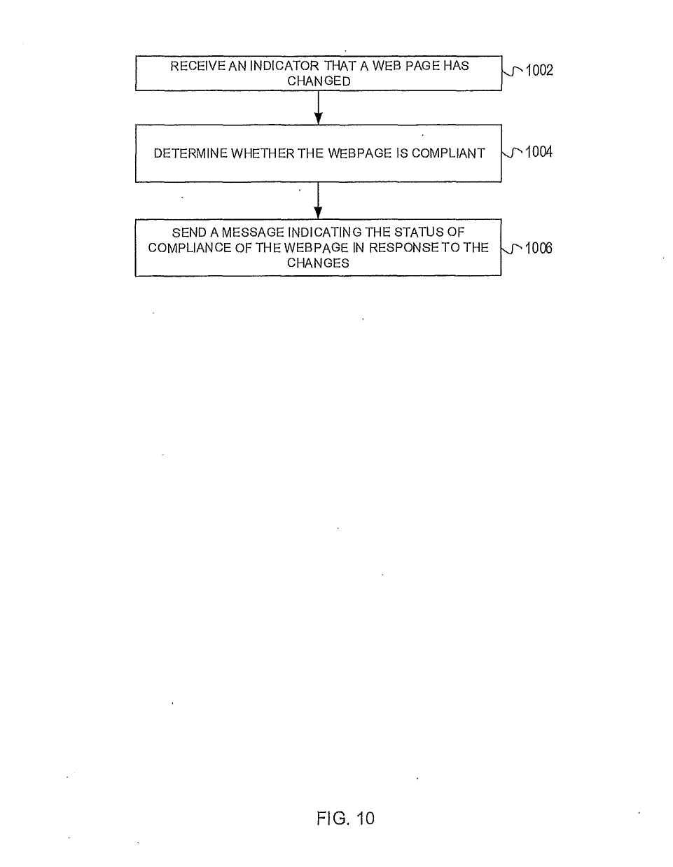

FIG. 10 is a flowchart of a process for determining compliance of a webpage in accordance with an illustrative embodiment. In many cases it may be difficult to ensure that a webpage stays at a set level of compliance. The illustrative embodiments provide an automatic and real-time method of determining compliance of the webpage with compliance rules, parameters, and factors.

The process of FIG. 10 may begin by receiving an indicator that a webpage has changed (step 1002). In one embodiment, the indicator may be a request for a website on an end-user device resulting in an error or something that cannot be accessed. For example, the user may provide the feedback that is communicated as the indicator. In one embodiment, the user may press a button, provide a gesture, send a message (e.g., email, text, chat, phone call, etc.), or otherwise indicated, there is an issue. The system may compare an archived copy of the original content to the content on the webpage to determine if a change has occurred.

In another embodiment, indicators may be received by an operator, technician, call center, technical support group, troubleshooting program, or so forth. The indicator may provide information about the issue and the end-user, such as time, website, type of device utilized by the user, and so forth.

Next, the system determines whether the webpage is compliant (step 1004). In one embodiment, the system may run a verification program that includes a number of rule sets to determine compliance of the website. The scan of the webpage may auto-detect the components of the webpage.

Next, the system sends a message indicating a status of compliance of the webpage in response to the changes (step 1006). In one embodiment, the status may indicate whether the webpage is compliant or non-compliant. The message may also indicate whether the system is going to intercede, interject content, wait, or present the changes later for evaluation or response.

The audio platform may not require publishers to take additional action, unless new content is being published that does not comply with minimum accessibility requirements. When audio-enabled publishers create new content with accessibility issues (e.g. an image was added to a webpage although no alternative text was provided) the compliance alerting system may generate notifications informing the publisher of changes needed to bring source content up to specification. The audio platform may also allow a services team to bring content up to specification at the publisher's request. The audio platform optimizes content and functionality for automatic processing and specific uses cases. Enhancements, improvements, and adaptation of the audio platform do not require any maintenance from publisher clients as production publications are distributed through the audio cloud-based software as a service solution.

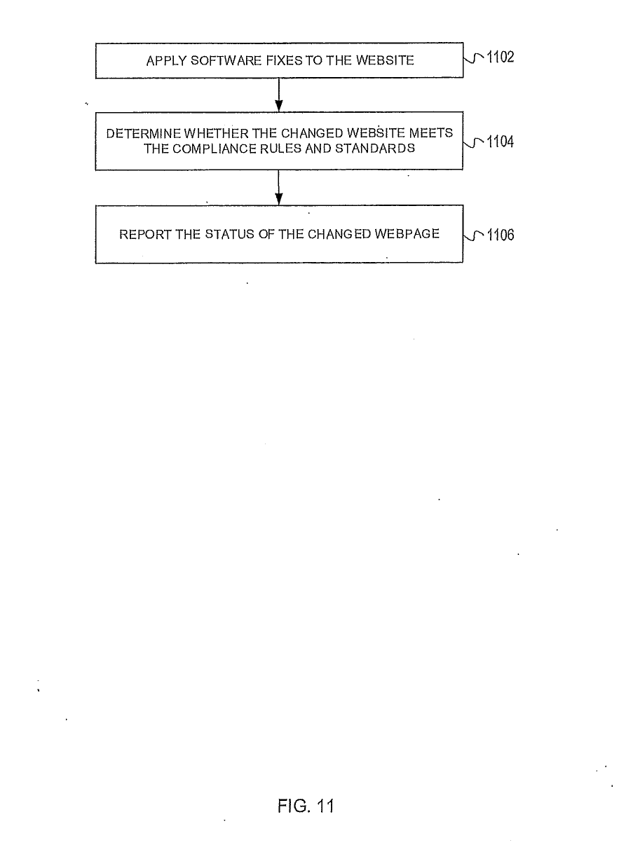

FIG. 11 is a flowchart of a process for automatically configuring a webpage in accordance with an illustrative embodiment. The process of FIG. 11 may begin by applying software fixes to the website (step 1102). In one embodiment, the software fixes may represent Javascript code that address one or more issues. Javascript is an object-oriented computer programming language commonly used to create interactive effects within web browsers. The software fixes may also represent HTML 5 or other developing code languages, patches, or modules. The software fixes may also represent layout helpers that configure and optimize the website to comply with compliance rules applicable to the web site.

Next, the system determines whether the changed website meets the compliance rules and standards (step 1104). In one embodiment, any number of rules sets and standards (e.g., rules previously created in JavaScript overlay) may be utilized before the player is loaded to determine whether the website is compliant or whether remediation is required to bring the website into compliance. In one example, all or portions of the website may include or be assigned digital identifiers (or tags) and the identifiers may be scanned to determine whether the website has changed since the last scan.

Next, the system reports the status of the changed webpage (step 1106). The status of the changed webpage may be reported through automated messages, in-application messaging, phone calls, text messages, or so forth. The reports may utilized to determine whether the problem were previously reported, acknowledged, checked by a user or program administrator, being processed, fixed or so forth. As previously noted, any issues may be remediated using layout helpers and other fixes to ensure that the user has a more consistent experience utilizing the audio platform. As a result, the automated compliance testing is performed and rule-based accessibility fixes may be applied as needed for compliance remediation.

In one embodiment, in response to determining the system complies with the compliance rules and standards, the system may implement the audio player for the user. The audio player may communicate the content of the webpage to the user at least audibly. In addition, other tools may be utilized to communicate with the user. For example, audio generation of the webpage content may be invoked in response to a request from a user. The user may utilize an audible keyboard navigation system.

In one embodiment, the system may store the website updates for utilization by other users that access the webpage. For example, the changes may be saved to a repository, such as a database with information associated with the webpage for subsequent utilization by a number of other users. As a result, site updating becomes inconsequential and may be performed more efficiently saving thousands of dollars over time.

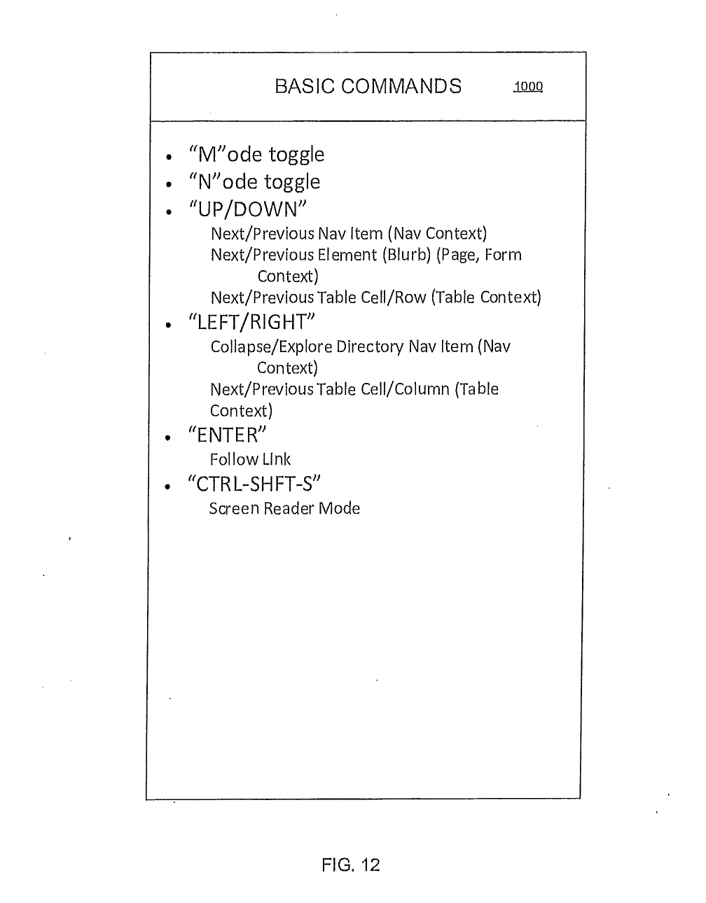

FIG. 12 is a pictorial representation of basic commands for an audio player in accordance with an illustrative embodiment. The basic commands 1000 may be utilized to interact with the software utilizing a keyboard, soft keys, mouse, voice commands, braille keyboard, or other input devices. The basic commands 1000 may represent selections, indicators, or other information received in any number of ways. In one embodiment, basic commands 1000 may include “M”ode toggle and “N” toggle. The basic commands 1000 may also include the up down arrows or “Up/Down” may be utilized to select the next/previous navigation item (in the navigation context), next, previous element (blurb, page, form context), and next/previous table cell/row (in the table context). The basic commands 1000 may also include the left/right arrows or “Left/Right” that may be utilized to collapse/explore directory navigation items (in the navigation context) or to select the next/previous table cell/column (in the table context).

The basic commands 1000 may also allow an “enter” selection to follow a link or source. By selecting “CTRL-SHFT-S” may be utilized to select a screen reader mode.

The interface may allow a click to listen feature. In a site display mode the user may click elements to hear audio playback of an element (e.g. image to hear alternative text, paragraph to read paragraph, etc.). In a reader display mode the user may click words within a paragraph to resume audio playback from that specific word.

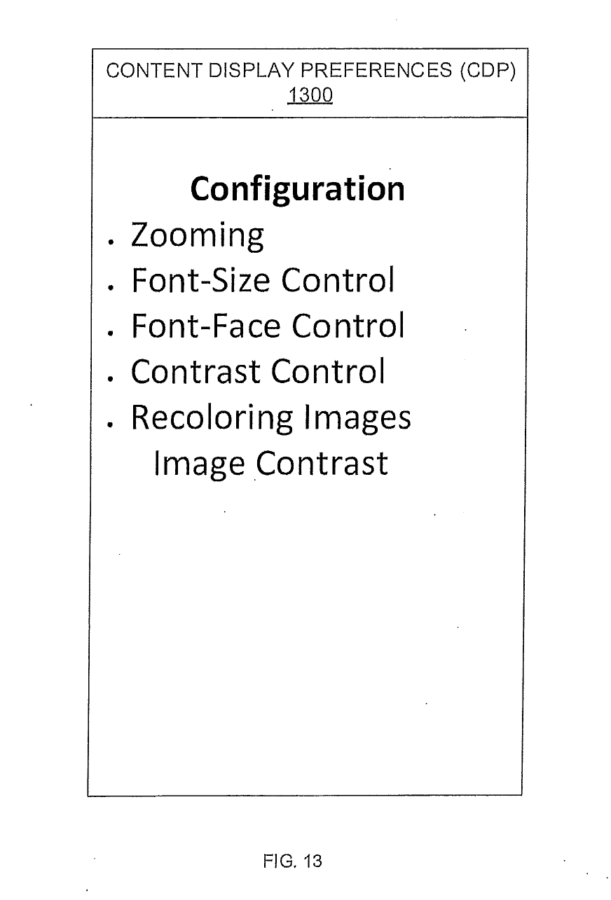

FIG. 13 is a pictorial representation of content display preferences 1300 in accordance with an illustrative embodiment. In one embodiment, the content display preferences 1300 are one example of user permissions and preferences that may be established using an interface, such as a mobile application or portal.

The content display preferences 1300 may allow a user to control zooming, font-size control, font-face control, contrast control, and image color, and image contrast. The content display preferences 1300 may also allow a user to select languages, fonts, menus, and so forth. In one embodiment, the user may include preferences for recoloring each image based on user preferences. In another embodiment, the user may change individual images or groups of images. For example, a slider or control may allow the color scheme including utilized colors to be adjusted so those with vision problems are able to effectively perceive the content of the image. For example, the colors reds, greens, blues, yellows, and other colors or combinations may be adjusted. In one embodiment, the website provider may control the different color formats that are available (e.g., for people with normal vision, protanope, deuteranope, and tritanope vision). For example, a number of different images may be selected from a single image (e.g., no red, no green, no blues, only black and white, etc.).

The various systems, methods, devices, and embodiments herein described may also allow for implementation and execution of a number of distinct features. For example, an immersion reading feature of an application may enable real-time highlighting. During the immersion reading, the audio, whether automatically generated or voice recorded is synchronized with a transcript (e.g., a text description). The immersion reader may require a timing file to perform text-to-speech conversion or may utilize a commercial transcript alignment service.

The embodiments may also implement a click-to-listen feature. The click-to-listen feature may be accessed from an element level (blurb) and word level and may be accessed from in a reader display mode and site display modes. In the reader display mode, the user may click words within a paragraph to resume audio playback from that specific word. In the site display mode, the user may click on specific elements to hear audio playback associated with the specific elements (e.g. selection of an image to hear alternative text, selection of a paragraph to read the paragraph, etc.).

The illustrative embodiments may perform automated form handling. For example, the platform may utilize a set of heuristics and rules to identify each element of a form and normalize the form's display to the end-user. The automated form handling helps reduce overall development time, end-user implementation efforts, and possible errors and omissions.

The illustrative embodiments may perform document handling. For example, the platform may perform text based and imaged based document to audio conversion. In one embodiment, the platform may utilize a phased approach for document handling which may include i) text based word, spreadsheet, and pdf files, 2) imaged based pdf files (e.g. utilizing optical character recognition), and 3) manual conversions (e.g., via a web portal or interface). Additional research may be required for XML handling which may vary from client to client.

In one embodiment, automatic real-time recognition and processing of documents may be performed. For example, the audio platform may search a cache, database, or repository to determine if one or more documents have already been converted to audio content. If already available, the audio platform may utilize the previously converted audio content associated with the document(s). If the one or more documents have not been previously converted to audio content, the audio platform may perform OCR on the document and convert the text to an HTML or other similar format for use by the audio player. The converted content may then be utilized to generate audio content. The audio version of the one or more documents may then be cached for use by other websites, users, or accessing parties.

The illustrative embodiments determine whether a navigation menu or searching is available through a website. In one embodiment, the audio platform enables keystroke navigation of the audio content. For example, a default navigation program may be enabled, such as those used for screen readers. The user may also select to utilize control schemes that already exist (e.g., JAWS, NVDA, VoiceOver, etc.). In another embodiment, each feature of the audio system may be configured by a user. For example, for each feature or navigation option, the user may be presented with a manner of reconfiguring the navigation to a preferred method selected by the user. A user may select to move forward and back through the website utilizing the arrow keys of the keyboard. Selecting to view or press “enter” may be done through a voice command. Bringing up a search feature may be performed by a tactile input. Any number of controls or actions including keyboard, dedicated or soft button presses, eye tracking, voice control, braille controls, tactile input, breathing tubes, gesture control, mouse movements, or other devices.

The illustrative embodiments may also provide compliance, conflict, and other alerts and notifications. For example, the platform provides a Web Content Accessibility Guideline (WCAG) compliant solution. The platform may automatically detect compliance shortfalls. For example, reports may be made available in a portal. In addition, alerts may be triggered based on conditions and factors to be sent to various individuals or stakeholders. The platform may fix the problems at the source. For example, automatic messages or alerts may educate a user on appropriate fixes to content when generated or updated to avoid potential compliance conflicts. The platform may also automatically generate one or more work arounds. For example, the portal may generate updates to resolve conflicts for properly displaying one or more of the user interfaces.

The audio platform available to the user may be packaged as SaaS. In one embodiment, control of client permissions may be managed through a portal. For example, the SaaS may include three packages (e.g. bronze, silver, gold). Variables in the different packages may include the number of seats allowed (e.g., based on total site traffic, monthly unique views, etc.). The variables may also include the type of text-to-speech engine utilized (e.g. iSpeech for premium TTS users, TTS-API for standard users). The variables may also include immersion reading, click to listen features (e.g. may require a premium TTS), and professional voicing (e.g., may be sold as hourly packages). The variables may also include whether layout helpers are required (e.g. for document conversions). Add-on features for the SaaS may include closed captioning, translation, and multiple language support.

In one embodiment, content in the website may also be categorized. The content may be separated utilizing different font colors, background colors, border patterns, or so forth. For example, news content may have an orange outline or background with a solid black border, entertainment may have a blue background with a diagonal patterned border, advertisements may have a black dotted border, and so forth. The user may customize how the information is presented (e.g., one or more Font size, color, format, border color, pattern, and shape, and background/highlight color or pattern) and may select to include a legend that shows how the information is customized as part of the settings or preferences.

In another embodiment, the user may select to darken or brighten one or more lines or portions of the webpage or a section based on a mouse movement, user selections or navigations commands, visual eye tracking or so forth. The audio platform may distinguish the content based on a selection by the user. This may be helpful for users with vision, concentration or other problems. The other portions of the webpage may be similarly made much lighter or may appear transparent, semi-transparent, or translucent. In another embodiment, one word or multiple words may be highlighted at a time. In another embodiment, the one word, sentence, or section may fill the screen. The one word, sentence, or section may move based on a user selection, scroll, move as a slideshow, fade in and out, or so forth.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

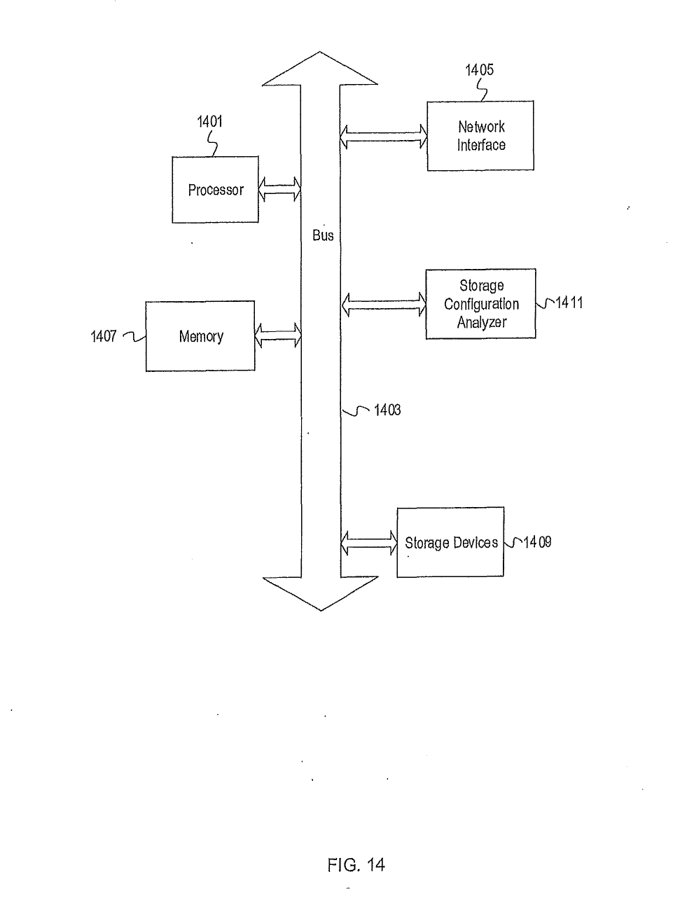

FIG. 14 depicts an example computer system 1400. A computer system 1400 includes a processor unit 1401 (possibly including multiple processors, multiple cores, multiple nodes, and/or implementing multi-threading, etc.). The computer system includes memory 1407. The memory 1407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1403 (e.g., PCI, ISA, PCI-Express, HyperTransport®, InfiniBand®, NuBus, etc.), a network interface 1405 (e.g., an ATM interface, an Ethernet interface, a Frame Relay interface, SONET interface, wireless interface, etc.), and a storage device(s) 1409 (e.g., optical storage, magnetic storage, etc.). The system memory 1407 embodies functionality to implement embodiments described above. The system memory 1407 may include one or more functionalities that facilitate retrieval of the audio information associated with an identifier. Code may be implemented in any of the other devices of the computer system 1400. Any one of these functionalities may be partially (or entirely) implemented in hardware and/or on the processing unit 1401. For example, the functionality may be implemented with an application specific integrated circuit, in logic implemented in the processing unit 1401, in a co-processor on a peripheral device or card, etc. Further, realizations may include fewer or additional components not illustrated in FIG. 14 (e.g., video cards, audio cards, additional network interfaces, peripheral devices, etc.). The processor unit 1401, the storage device(s) 1409, and the network interface 1405 are coupled to the bus 1403. Although illustrated as being coupled to the bus 1403, the memory 1407 may be coupled to the processor unit 1401.

The illustrative embodiments allow publishers and content providers full control over the accessibility of their web and digital assets and environments allowing the providers to recognize, remediate, and report real-time accessibility status. The embodiments may allow the provider to identify compliance issue through both automated and manual testing. Site-specific layout helpers may be utilized to remediate compliance shortfalls making code of the content accessible to the audio platform screen reader users and other options. Providers have real-time access to view and understand the compliance and usability issues identified through testing and the respective remediation techniques. Code fixes may be utilized for quality improvements to the future content.

While the embodiments are described with reference to various implementations and exploitations, it will be understood that these embodiments are illustrative and that the scope of the inventive subject matter is not limited to them. In general, techniques for tracking items and communicating audio information associated with the audio trackers as described herein may be implemented with devices, facilities, or equipment consistent with any hardware system(s). Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of populating an on-line form using voice interaction, comprising:
parsing the form into: i) a first field to be filled in by a user; and ii) a first text identifier associated with the first field;
converting the first text identifier to first synthesized speech;
playing the first synthesized speech aloud to thereby prompt the user to respond with a first verbal answer;
converting the first verbal answer to a first text response; and
inserting the first text response into the first field.

2. The method of claim 1, further comprising:
parsing the form into: i) a second field to be filled in by the user;
and ii) a second text identifier associated with the second field;
converting the second text identifier to second synthesized speech;
playing the second synthesized speech aloud to thereby prompt the user to respond with a second verbal answer;
converting the second verbal answer to a second text response; and
inserting the second text response into second field.

3. The method of claim 1, wherein the first text identifier comprises one of: name; date of birth; and social security number.

4. The method of claim 1, wherein the first identifier comprises a question.

5. The method of claim 1, further comprising:
receiving a first indication that the user has navigated a web page until the form is encountered; and
receiving a second indication that the user has selected to enter information into the form.

6. The method of claim 5, wherein the first indication comprises one of a hardware key, soft key, gesture, mouse click, and voice command.

7. The method of claim 5, wherein the second indication comprises one of a hardware key, soft key, gesture, mouse click, and voice command.

8. The method of claim 1, wherein parsing comprises using heuristics to identify the first field and the first text identifier.

9. A method of monitoring website compliance with accessibility guidelines, comprising:
storing an archive copy of a compliant web page;
receiving an indicator that the webpage has changed;
comparing the archived copy to the then current version of the web page;
identifying a difference between the archived copy to the then current version of the web page; and
determining whether the difference complies with the accessibility guidelines.

10. The method of claim 9, wherein the indicator comprises a request for a website on an end-user device resulting in an error.

11. The method of claim 9, wherein the indicator comprises user feedback in the form of a button press, gesture, email, text, chat, or phone call.

12. The method of claim 9, further comprising, in response to a determination that the difference is non-compliant, automatically remediating the non-compliance.

13. The method of claim 12, wherein automatically remediating comprises at least one of: interceding; interjecting content; waiting; and presenting changes for evaluation.

14. The method of claim 12, wherein automatically remediating comprises implementing rule-based accessibility fixes in real time.

15. A method for onboarding content, comprising:
identifying content being made available to an audio player;
creating content selectors for the audio player to access the identified content;
developing layout helpers for the dynamic content;
creating the layout helpers based on examined forms; and
including the audio player loader in access files.

16. The method of claim 15, wherein the content comprises digital content available through a website or mobile application.

17. The method of claim 15, further comprising performing a survey of a website to identify the content.

18. The method of claim 15, wherein the layout helpers are configured to enable the audio platform to accurately identify and interpret applying custom rules.

19. The method of claim 15, wherein the layout helpers are developed for AJAX.

20. The method of claim 15, wherein the layout helpers are configured for non-standard source content.
